(19) United States
(12) Patent Application Publication
(10) Pub. No.: US 2005/0167633 A1
(43) Pub. Date: Aug. 4, 2005

(54) Heat-storage medium II

(76) Inventors: Ralf Glausch, Muhltal (DE); Mark Neuschutz, Darmstadt (DE); Wolfgang Voight, Weisseborn (DE); Carsten Rudolph, Freiberg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/513,655

(22) PCT Filed: Apr. 16, 2003
(86) PCT No.: PCT/EP03/04009

(30) Foreign Application Priority Data
May 8, 2002 (DE) 102 20 516.7

(51) Int. Cl. C09K 3/18

(52) U.S. Cl. 252/70

(57) ABSTRACT

The present invention relates to phase change materials (PCMs) for the storage of thermal energy in the form of phase change heat based on lithium nitrate trihydrate, and to the use thereof.

The present invention relates to lithium nitrate trihydrate-based phase change materials (PCMs) for the storage of thermal energy in the form of phase change heat, and to the use thereof.

Heat peaks or deficits frequently have to be avoided in industrial processes, i.e. thermostatting is necessary. To this end, use is usually made of heat exchangers. They contain heat transfer media which transport heat from one site or medium to another. In order to dissipate heat peaks, use is made, for example, of the release of the heat to the air via a heat exchanger. However, this heat is then no longer available for compensating for heat deficits. This problem is solved by the use of heat-storage systems.

Known storage media are, for example, water or rocks/concrete for storing sensible heat or phase change materials (PCMs), such as salts, salt hydrates or mixtures thereof, for storing heat in the form of heat of fusion (“latent heat”). It is known that when a substance melts, i.e. is converted from the solid phase into the liquid phase, heat is consumed, i.e. is taken up, and is stored as latent heat so long as the liquid state still exists, and that this latent heat is liberated again on solidification, i.e. on conversion from the liquid phase into the solid phase.

The charging of a heat-storage system basically requires a higher temperature than can be achieved during discharging, since a temperature difference is necessary for the transport/flow of heat. The quality of the heat is dependent on the temperature at which it is available again: the higher the temperature, the more ways the heat can be employed. For this reason, it is desirable for the temperature level during storage to drop as little as possible.

In the case of the storage of sensible heat (for example by heating water), the input of heat is accompanied by constant heating of the storage material (and the opposite during discharging), while latent heat is stored and discharged at the melting point of the PCM. Latent heat storage therefore has the advantage over the storage of sensible heat that the temperature loss is restricted to the loss during heat transport from and to the storage system.

As storage medium in latent heat-storage systems, use is usually made hitherto of substances which have a solid-liquid phase transition in the temperature range which is essential for the use, i.e. substances which melt during use.

Inorganic salts and in particular their hydrates are, as is known, substances which have the highest specific heats of fusion and are therefore favoured as latent heat-storage medium (PCMs). In addition to a suitable melting point and heat of fusion, their use in industry depends on a number of further properties, such as supercooling and stratification, which greatly restricts the application of the few PCMs known to date. In particular in the area of supercooling of PCMs, numerous attempts have been made in the past to find effective crystallisation initiators.

The literature contains only a few studies on the melting and solidification behaviour of lithium nitrate trihydrate.

One possible cause of the sparse state of knowledge is that the degree of supercooling of lithium nitrate trihydrate melts is highly dependent on the superheating conditions of the melt. The term superheating conditions is taken to mean the duration and level of calcination above the melting point. This behaviour is less pronounced in the salt hydrates that have been studied intensively, such as sodium acetate trihydrate.

Studies have been carried out on the supercooling behaviour of lithium nitrate trihydrate with respect to the superheating duration and temperature.

Without supercooling, LiNO₃*3H₂O would have to solidify at 29° C. It became clear that, with increasing superheating of the melts, the number of supercooling samples and the degree of supercooling increases significantly. The predominant part of the samples then crystallises at between 0° C. and 10° C. A trend of this type is not evident for the superheating duration.

It is furthermore known that supercooling increases greatly on the microscale. This supercooling behaviour has so far prevented the use of lithium nitrate trihydrate as PCM.

Shoka in JP 07118629 describes a BaZrO₃ nucleating agent for a PCM based on a mixture of LiNO₃ and Mg(NO₃)₂*6H₂O.

Investigations of lithium nitrate trihydrate have shown that no decrease in supercooling can be observed through the addition of BaZrO₃ in this case.

The mixture of MgCO₃ and MgO proposed by Laing in JP 53006108 also exhibits no reduction in the supercooling of lithium nitrate trihydrate melts.

The object was to avoid the supercooling of lithium nitrate trihydrate. A maximum PCM charging temperature of 95° C. should be ensured. Cooling steps to below room temperature should be avoided during the preparation of active nucleating agents.

Accordingly, the present invention relates firstly to a heat-storage medium comprising
a) lithium nitrate trihydrate and
b) a mixture of at least two compounds selected from the group consisting of magnesium nitrate, nickel nitrate, strontium nitrate, magnesium acetate, nickel acetate and strontium acetate or hydrates thereof, where at least one compound from the nitrate group is present, and
c) optionally relatively high-melting nitrates.

The invention relates secondly to the process for the preparation of a medium, characterised in that
a) the mixture of at least two compounds selected from the group consisting of magnesium nitrate, nickel nitrate, strontium nitrate, magnesium acetate, nickel acetate and strontium acetate or hydrates thereof, where at least one compound from the nitrate group is present, are dissolved in water or a mixture with a suitable organic solvent, where the proportion of the individual components in the mixture is in the range from 10 to 90 mol %,
b) the solution is evaporated, and the crystals obtained or the melt of the fusible hydrates are calcined,
c) the mixture obtained from b) is mixed with lithium nitrate trihydrate, if desired in gelled or thickened form, and melted and, after cooling to below the melting point, crystallised.

For the preparation of pure nitrate mixtures, the corresponding oxides, hydroxides or carbonates can also be reacted with nitric acid and heated.

The invention furthermore relates to the use of the above-mentioned medium, if desired with auxiliaries, as storage medium in latent heat-storage systems, for thermostatting buildings, in plaster or in or on Venetian blinds, and in air-conditioning units for motor vehicles, transport or storage facilities.

In addition the medium according to the invention can be used in clothing for thermostatting.

For the purposes of the present invention, the term thermostatting is taken to mean both thermal insulation and thus the maintenance of a temperature, as well as the absorption of brief temperature variations or peaks. Applications can exist both in heat storage and selective release, and in absorption of heat and consequently cooling.

The heat-storage medium according to the invention is defined as a phase change material (PCM) which is in the form of a combination with a nucleating agent and, if desired, a relatively high-melting nitrate.

The nucleating agent is a mixture according to the invention of at least two compounds selected from the group consisting of magnesium nitrate, nickel nitrate, strontium nitrate, magnesium acetate, nickel acetate and strontium acetate. The nucleating agent here comprises at least one compound from the nitrate group. In addition, the respective hydrates of these compounds can also be employed.

Preference is given to the use of binary and ternary mixtures. Particular preference is given to the systems magnesium nitrate/nickel acetate/strontium nitrate, magnesium nitrate/nickel acetate, nickel acetate/strontium nitrate, magnesium nitrate/strontium nitrate or hydrates thereof.

It has been found that the media according to the invention exhibit significantly more reliable nucleation for supercooled lithium nitrate trihydrate melts than the BaZrO₃ or MgCO₃ and MgO mixtures described in the literature.

It has also been found that cooling to below room temperature is not necessary for activation of the nucleating agents. Surprisingly, it has been found that the crystallisation initiators exhibit reliable nucleation up to superheating of the PCM to 95° C.

The supercooling which occurs on maximum superheating to 95° C. is between 5 and 7 K.

The composition of the mixtures is in the range from 10 to 90 mol %, preferably from 30 to 70 mol %. The salts are dissolved in water or in a mixture with organic solvents. They are preferably dissolved in water and mixtures thereof with acetone or alcohol.

The solution is evaporated to dryness at temperatures between room temperature and 120° C., depending on the solvent used, and the crystals are subsequently calcined. The calcination is carried out for 10-80 hours, preferably 48 hours, at temperatures between 50 and 150° C., preferably at 100° C.

The mixtures can likewise be formed using the fusible hydrates of these salts.

Repetition of the melting and crystallisation step results in an improvement in the crystallisation. In the case of 3 cycles, it is virtually 100% of the samples tested, within from 5 to 7 K supercooling.

It has been found that even small amounts (a few microlitres) of the mixtures crystallise with comparable supercooling. The material is thus particularly suitable for microencapsulation.

The PCM lithium nitrate trihydrate is melted with a proportion of from 0.5 to 10% by weight of nucleating agent. Preference is given to the use of from 1 to 3% by weight, particularly preferably 2% by weight, of nucleating agent. The melting point of lithium nitrate trihydrate is 29° C. In mixtures with nucleating agents and additives, it is in the range 18-29° C. After cooling to below the melting point, the crystallisation can additionally be initiated by acoustic or mechanical loading.

In order to lower the melting point of the lithium nitrate trihydrate, alkali or alkaline earth metal nitrates can optionally be added.

Sodium nitrate and/or magnesium nitrate can preferably be used. The alkali or alkaline earth metal nitrates can be added to the PCM in amounts of between 1 and 50% by weight, preferably between 5 and 15% by weight.

For homogeneous distribution of the nucleating agent in the PCM, the PCM may, if desired, be gelled or thickened. For the gelling or thickening, auxiliaries known to the person skilled in the art, such as, for example, derivatives of cellulose or gelatine, can be added to the PCM.

The PCM/nucleating agent mixtures according to the invention can be micro- or macroencapsulated, if necessary with addition of further auxiliaries.

Microencapsulated PCM/nucleating agent mixtures can be used in clothing for thermostatting, if desired with addition of further auxiliaries and/or alkali and/or alkaline earth metal nitrates.

The following example is intended to explain the invention in greater detail, but without representing a limitation.

### EXAMPLES

### Example 1

The nucleating agents employed are mixtures of magnesium nitrate, nickel acetate and strontium nitrate from the following four systems, preferably from the ternary system.
magnesium nitrate/nickel acetate/strontium nitrate
magnesium nitrate/nickel acetate
magnesium nitrate/strontium nitrate
nickel acetate/strontium nitrate.

The composition of the mixtures takes place in a range between 10 and 90 mol % of the respective corresponding salts.

For the formation of the mixtures, an aqueous solution consisting of the salts in the above ratio or a mixture of the fusible hydrates of these salts is prepared. The aqueous solution is evaporated to dryness at about 100° C., and the crystals are calcined for a period, preferably 48 hours, at about 100° C.

For reliable crystallisation, the PCM lithium nitrate trihydrate is mixed with a proportion of >1% by weight of nucleating agent.

By way of example, 2 nucleating agents comprising the ternary system with the designation 5/2/1 and 1/3/6 are prepared by the above processes and tested.

Nucleating agent 5/2/1:

mixture of equimolar standard solutions in the volume ratio 5:2:1 of the salts magnesium nitrate/nickel acetate/strontium nitrate

Nucleating agent 2/3/6:

mixture of equimolar standard solutions in the volume ratio 1:3:6 of the salts magnesium nitrate/nickel acetate/strontium nitrate

10 samples of PCM each comprising 1 ml of lithium nitrate trihydrate melt and 2% by weight of nucleating agent are prepared and calcined. This corresponds to 5 samples with nucleating agent 5/2/1 and 5 samples with nucleating agent 2/3/6. The calcination conditions are shown in Table 1.

In the subsequent cooling step at 1 K/min, the crystallisation temperatures are recorded and are likewise shown in Table 1.

TABLE 1
crystallisation temperatures of calcined lithium nitrate trihydrate melts
with 2% by weight of nucleating agent

| | | Cycle a: | Cycle b: | Cycle c: | Cycle d: | Cycle e: | Cycle f: |
|---|---|---|---|---|---|---|---|
| | | 65° C./ | 65° C./ | 65° C./ | 65° C./ | 95° C./ | 95° C./ |
| | Mixture | 90 min | 90 min | 120 min | 120 min | 120 min | 120 min |
| 1 | 5/2/1 | 26 | 28 | 29 | 29 | 29 | 28 |
| 2 | 5/2/1 | 26 | 28 | 29 | 29 | 29 | 28 |
| 3 | 5/2/1 | 26 | 28 | 29 | 29 | 29 | 28 |
| 4 | 5/2/1 | 26 | 28 | 29 | 29 | 29 | 28 |
| 5 | 5/2/1 | 26 | 28 | 29 | 29 | 29 | 28 |
| 6 | 1/3/6 | 26 | 28 | 28 | 28 | 28 | 28 |
| 7 | 1/3/6 | 26 | 28 | 28 | 28 | 28 | 28 |
| 8 | 1/3/6 | 26 | 28 | 28 | 28 | 29 | 28 |
| 9 | 1/3/6 | 26 | 28 | 28 | 28 | 28 | 28 |
| 10 | 1/3/6 | 26 | 28 | 28 | 28 | 28 | 28 |
| avg. | 5/2/1 | 26 | 28 | 29 | 29 | 29 | 28 |
| avg. | 1/3/6 | 26 | 28 | 29 | 29 | 29 | 28 |

DSC measurements of the nucleating agents 5/2/1 and 2/3/6 are carried out at between 5 and 95° C. at a heating rate of 2 K/min on sample volumes in the μl range. The results are shown in Table 2.

TABLE 2
DSC measurements of two samples each with 2% by weight of nucleating
agent 5/2/1 and 1/3/6

| | Cycle a | Cycle b | Cycle c | | |
|---|---|---|---|---|---|
| | 5 [symbol] | 5 [symbol] | 5 [symbol] | Cycle d | Cycle e |
| Mixture | 65° C. | 65° C. | 65° C. | 5 [symbol] 95° C. | 5 [symbol] 95° C. |
| 5/2/1 | 23.1° C. | 23.4° C. | 23.2° C. | 24° C. | 23.1° C. |
| 1/3/6 | 23.1° C. | 23.1° C. | 23.7° C. | 25.3° C. | 25.2° C. |

1. Heat-storage medium comprising
a. lithium nitrate trihydrate and
b. a mixture of at least two compounds selected from the group consisting of magnesium nitrate, nickel nitrate, strontium nitrate, magnesium acetate, nickel acetate and strontium acetate or hydrates thereof, where at least one compound from the nitrate group is present,
c. and optionally relatively high-melting nitrates.

2. Heat-storage medium according to claim 1, characterised in that the proportion of the individual components in the mixture is in the range from 10 to 90 mol %.

3. Heat-storage medium according to claim 1, characterised in that the proportion of the mixture is between 0.1 and 10% by weight, preferably between 1 and 3% by weight, particularly preferably 2% by weight.

4. Heat-storage medium according to claim 1, characterised in that the relatively high-melting nitrates added are alkali and/or alkaline earth metal nitrates in the range 1-50% by weight, preferably 5-15% by weight.

5. Heat-storage medium according to claim 1, characterised in that the medium is encapsulated.

6. Process for the preparation of a medium according to claim 1, characterised in that
a. the mixture of at least two compounds selected from the group consisting of magnesium nitrate, nickel nitrate, strontium nitrate, magnesium nitrate, nickel acetate and strontium acetate or hydrates thereof, where at least one compound from the nitrate group is present, are dissolved in water or a mixture with a suitable organic solvent, where the proportion of the individual components in the mixture is in the range from 10 to 90 mol %,
b. the solution is evaporated, and the crystals obtained or the melt of the fusible hydrates are calcined,
c. the mixture obtained from b) is mixed with lithium nitrate trihydrate, if desired in gelled or thickened form, and melted and, after cooling to below the melting point, crystallised.

7. Process according to claim 6, characterised in that the calcination is carried out at temperatures between 50 and 150° C., preferably at 100° C.

8. Use of a medium according to claim 1, if desired together with auxiliaries, as storage medium in latent heat-storage systems.

9. Use of a medium according to claim 1 for thermostatting buildings, in plaster or in or on Venetian blinds.

10. Use of a medium according to claim 1 in air-conditioning units for motor vehicles, transport or storage facilities.

11. Use of a medium according to claim 1 in clothing.
